(19) United States
(12) Patent Application Publication
(10) Pub. No.: US 2004/0144553 A1
(43) Pub. Date: Jul. 29, 2004

(54) Variable speed reversible power tool

(75) Inventor: Kurt E. Ashbaugh, Beavercreek, OH (US)

Correspondence Address: Leon Nigohosian, Jr., Michael Best & Friedrich LLP, Suite 360, 3773 Corporate Parkway, Center Valley, PA, 18034, US

(73) Assignee: Ingersoll-Rand Company, Woodcliff Lake, NJ (US)

(21) Appl. No.: 10/351,068

(22) Filed: Jan. 24, 2003

(51) Int. Cl. B27C 3/08

(52) U.S. Cl. 173/169

(57) ABSTRACT

A pneumatic power tool including a housing formed to include a handle, an air motor positioned within the housing, and an air inlet passage through the handle, the air inlet passage being connectable with a source of pressurized air. The pneumatic power tool also includes a tilt valve positioned in the air inlet passage to control airflow through the tool. The pneumatic power tool also includes a rotatable reverse valve positioned within the housing, the reverse valve being rotatable between a first position to operate the motor in a first direction and a second position to operate the motor in a second direction, which is opposite the first direction. Further, the pneumatic power tool includes a slidable throttle shaft having a first end and a second end, the throttle shaft extending axially through the reverse valve, the first end of the shaft engaging the tilt valve and the second end of the shaft extending outside of the housing for engagement by a user to regulate the airflow past the tilt valve, and wherein the reverse valve includes a tab portion positioned adjacent to the second end of the shaft, the tab portion engageable by a user to move the reverse valve between its first and second positions.

### BACKGROUND OF THE INVENTION

This invention relates generally to power tools, and more particularly to air-operated power tools.

Air-operated power tools generally utilize a source of compressed air (or other gas) to drive an air motor, which is subsequently coupled to an output means associated with the particular type of power tool. For example, in the case of an air-operated drill, the air motor is coupled to a chuck. The chuck is adjustable to grasp any number of accessories, such as, for example, drill bits, screwdriver bits, abrasive bits, polishing bits, and so forth. Generally, air-operated power tools (including drills) include a series of internal passages to route the compressed air to and from the air motor. Further, for an air-operated reversible power tool, some sort of reversing valve is usually introduced to selectively guide the incoming compressed air to the proper internal passage(s) for normal operation and reverse operation.

For example, a conventional air-operated reversible drill selectively guides the incoming compressed air to the air motor via dual air intake passages. A first air intake passage provides the compressed air to the air motor to cause the air motor to rotate in a forward direction (clockwise), while a second intake passage provides the compressed air to the air motor to cause the air motor to rotate in a reverse direction (counter-clockwise). Most conventional reversing valves are manipulatable to guide the incoming compressed air to either the first or second air intake passage to select operation of the air motor. If, for example, the reversing valve provides compressed air to the first air intake passage, the reversing valve also typically fluidly blocks the second air intake passage from receiving any of the incoming compressed air. After being directed toward the air motor, the compressed air expands while flowing through the air motor, and the uncompressed air exhausts through an air exhaust passage and eventually to atmosphere.

It is generally known and practiced in the art to vent the blocked or unused air intake passage to atmosphere. By doing this, unwanted and unstable air pockets do not accumulate in the unused air intake passage, which remains fluidly connected with the air motor.

### SUMMARY OF THE INVENTION

One type of conventional reversing valve includes a push-button selector valve. The selector valve typically includes an elongated, cylindrically shaped body having multiple necked sections and push-button ends accessible from the exterior of the drill. The position of the necked sections of the selector valve determines which of the adjacent air intake passages is fluidly connected with the incoming compressed air. To change the direction of rotation of the air motor, and subsequently the chuck in the case of a drill, the appropriate push-button end of the selector valve is depressed. The push-button selector valve is typically positioned above and separately from the drill's trigger.

A conventional push-button selector valve requires its own bore machined in the drill housing. Because the construction of the selector valve prevents it from being integrated with, for example, the bore of the trigger, extra manufacturing processes are required to produce an air-operated reversible drill utilizing the conventional push-button valve, which typically leads to a more expensive product.

Also, to adjust the amount of air allowed through the selector valve, and thus the amount of torque developed by the air motor, the push-button valve typically requires rotation to progressively restrict or release the compressed air through the valve. To accomplish this, in addition to allowing axial “push-button” movement of the valve, additional components are usually required to aid the operator in rotating the valve. Such additional components sometimes include a detented lever coupled to the drill housing and the valve to provide rotation to the valve while allowing for its “push-button” movement.

The present invention provides a pneumatic power tool including a housing formed to include a handle, an air motor positioned within the housing, and an air inlet passage through the handle, the air inlet passage being connectable with a source of pressurized air. A tilt valve positioned in the air inlet passage controls airflow through the air inlet passage. The pneumatic power tool also includes a first air intake passage through the housing in fluid communication with the motor, and a second air intake passage through the housing in fluid communication with the motor. Further, the pneumatic power tool includes an air exhaust passage through the housing in fluid communication with the motor, and an air outlet passage through the handle in fluid communication with an exterior of the pneumatic power tool.

A rotatable reverse valve positioned within the housing fluidly couples the air exhaust passage and the air outlet passage and is rotatable between a first position fluidly connecting the air inlet passage to the first air intake passage to operate the motor in a first direction and a second position fluidly connecting the air inlet passage to the second air intake passage to operate the motor in a second direction, which is opposite the first direction. The pneumatic power tool also includes a throttle shaft having a first end and a second end and extending slidably through the reverse valve. The first end of the shaft engages the tilt valve and the second end of the shaft extends outside of the housing for engagement by a user to regulate the airflow past the tilt valve. A tab coupled to the reverse valve and positioned adjacent to the second end of the shaft is engageable by a user to move the reverse valve between its first and second positions.

The present invention also provides a pneumatic power tool including a housing formed to include a handle, an air motor positioned within the housing, an air inlet passage through the handle, the air inlet passage being connectable with a source of pressurized air, and a tilt valve positioned in the air inlet passage to control airflow through the air inlet passage. The pneumatic power tool also includes a first air intake passage through the housing in fluid communication with the motor, a second air intake passage through the housing in fluid communication with the motor, an air exhaust passage through the housing in fluid communication with the motor, and an air outlet passage through the handle in fluid communication with an exterior of the pneumatic power tool.

A rotatable reverse valve positioned within the housing includes an exhaust portion fluidly coupling the air exhaust passage and the air outlet passage, and an intake portion adjacent the exhaust portion. The intake portion is rotatable between a first position fluidly connecting the air inlet passage to the first air intake passage to operate the motor in a first direction, and a second position fluidly connecting the air inlet passage to the second air intake passage to operate the motor in a second direction opposite the first direction. The pneumatic power tool also includes a throttle shaft having a first end and a second end and extending slidably through the reverse valve. The first end of the shaft engages the tilt valve and the second end of the shaft extends outside of the housing for engagement by a user to regulate the airflow past the tilt valve. A tab coupled to the reverse valve and positioned adjacent to the second end of the shaft is engageable by a user to move the reverse valve between its first and second positions.

### BRIEF DESCRIPTION OF THE DRAWINGS

The detailed description particularly refers to the accompanying figures in which:

FIG. 1 is an exploded perspective view of a pneumatic power tool embodying the present invention, illustrating a variable speed reversible drill having a reversing valve and trigger assembly;

FIG. 2 is a partial cross-sectional plan view of the tool of FIG. 1; and

FIG. 3 is a partial cross-sectional end view of the tool of FIG. 1, with portions removed.

### DETAILED DESCRIPTION

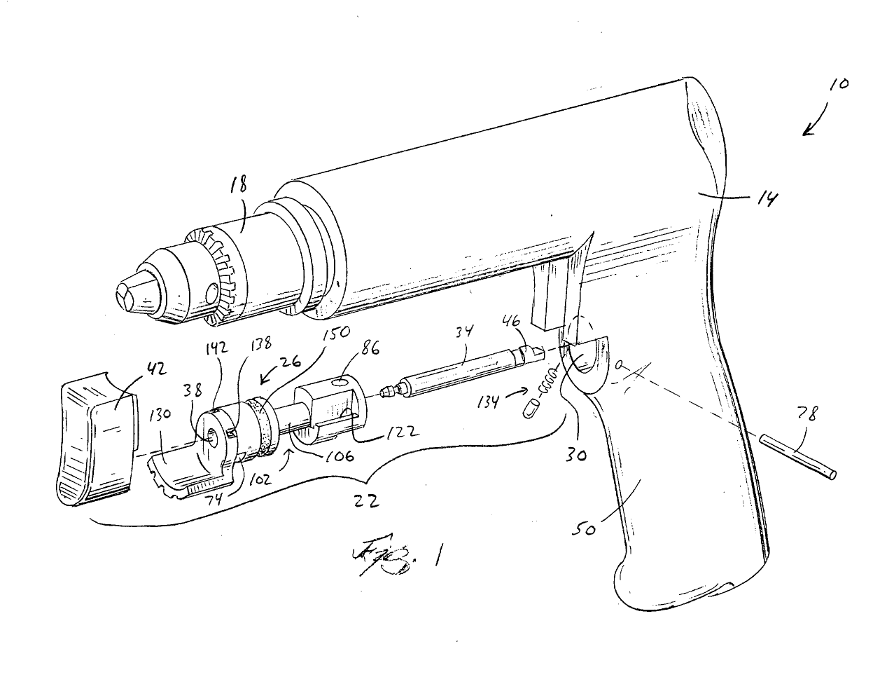

A pneumatic power tool according to the present invention is shown in FIGS. 1-3. In one construction of the invention shown here, the pneumatic power tool comprises an air-operated reversible drill 10, which utilizes a source of compressed air (not shown) to power an air motor (also not shown) contained by a drill housing 14. Further, the air motor is coupled to a chuck 18 via a suitable power transmission (again, not shown).

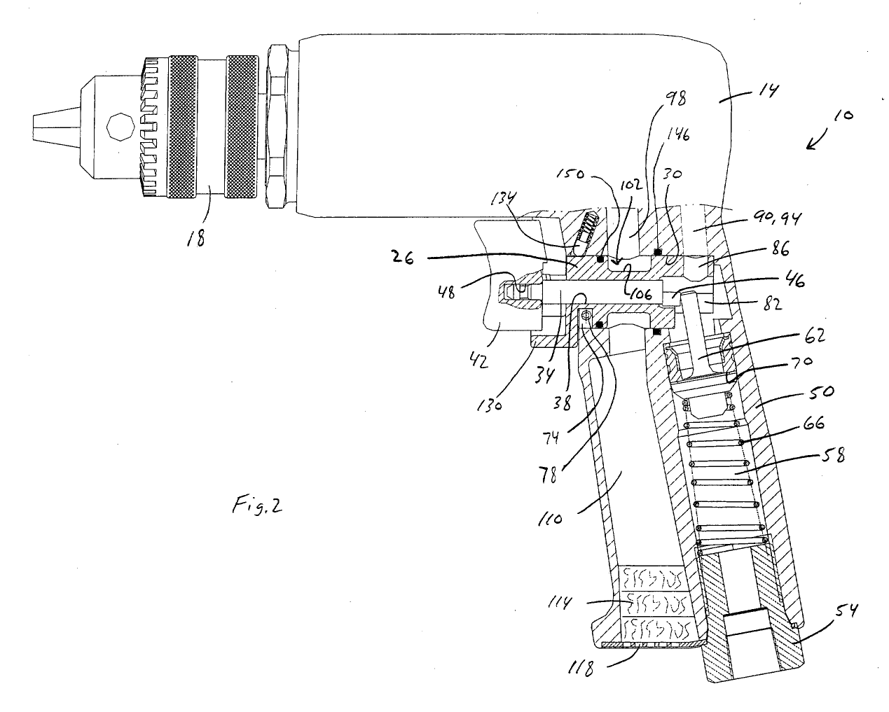

With reference to FIG. 1, the air-operated reversible drill 10 includes a reversing valve trigger assembly 22 exploded away from the drill 10. The trigger assembly 22 includes a reversing valve 26 having a generally cylindrical shape, such that the valve 26 is insertable into a blind bore 30 in the drill housing 14. A trigger shaft 34 is inserted through a centralized bore 38 through the reversing valve 26 and coupled to a trigger 42. The end opposite the trigger 42 includes a flared portion 46 limiting the stroke of the trigger shaft 34 through the valve 26. Similarly, the trigger 42 limits the stroke of the trigger shaft 34 on the trigger-end of the shaft 34. The trigger 42 is coupled to the trigger shaft 34 via an interference fit between the shaft 34 and a blind hole 48 (FIG. 2) in the trigger 42. Alternatively, the trigger 42 may be coupled to the shaft 34 in any one of a number of reasonable ways, including: fastening, welding, gluing, epoxying, using snap-fits, and so forth. In the construction shown in FIG. 1, the trigger 42 is made from plastic, while the trigger shaft 34 and reversing valve 26 are made from metal. Alternatively, the trigger shaft 34 may be made from metal, or the entire trigger assembly 22 may be made from plastic, etc.

With reference to FIG. 2, the drill housing 14 defines a handle 50. The handle 50 includes a coupling adapter 54 engaged with an air inlet passage 58 through the handle 50. The coupling adapter 54 receives a fitting (not shown) to releasably connect with an air hose (also not shown), which is fluidly connected with a source of compressed air. A tilt valve 62 is situated in the air inlet passage 58 and is supported by a compression spring 66. The compression spring 66 biases the tilt valve 62 against a sealing surface 70 in the air inlet passage 58, so that the compressed air may not pass the tilt valve 62 and sealing surface 70.

With further reference to FIG. 2, upon inserting the trigger assembly 22 into the blind bore 30 of the drill housing 14, the flared portion 46 of the trigger shaft 34 is engageable with the tilt valve 62 to enable it to at least partially displace the tilt valve 62 from the sealing surface 70 when the trigger 42 is depressed. The trigger assembly 22 is held in place in the blind bore 30 via a retaining groove 74 and pin 78 (FIG. 1). The retaining groove 74 is formed in the reversing valve 26, and upon insertion into the housing 14, the pin 78 is aligned with the groove 74. The groove 74 is formed in the valve 26 to allow rotation of the valve 26 relative to the housing 14, but not allow axial movement of the valve 26 relative to the housing 14.

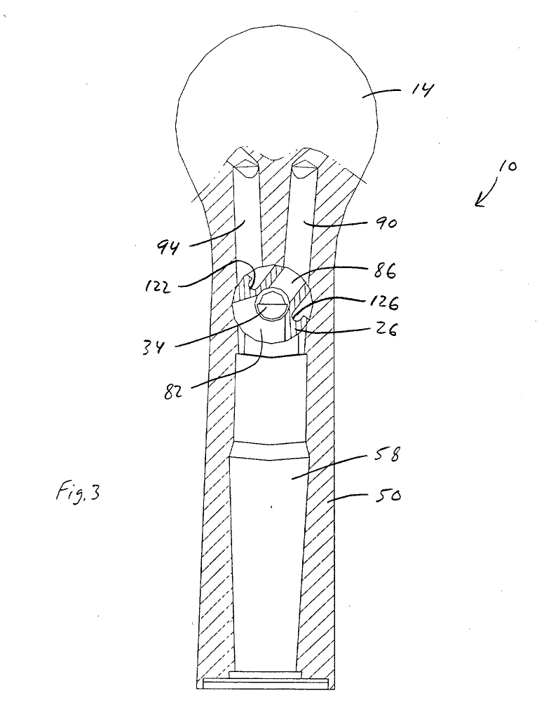

As shown in FIG. 2, the reversing valve 26 includes a valve inlet 82 and a valve outlet 86 fluidly connected with the air inlet passage 58 upon actuation of the trigger 42. The valve inlet 82 is defined by an opening over about 65 degrees of the valve's generally cylindrically shaped body (FIG. 3). The valve inlet 82 tapers toward the valve outlet 86, which is fluidly connected with the valve inlet 82. The valve outlet 86 is defined by a round bore through the valve 26.

With reference to FIG. 3, dual air intake passages 90, 94 are formed in the drill housing 14 and positioned above the valve outlet 86. Both of the air intake passages 90, 94 lead to the air motor and provide the air motor with compressed air to drive the air motor. A first air intake passage 90 provides compressed air to the air motor to drive the motor in a forward, or clockwise direction. Similarly, a second air intake passage 94 provides compressed air to the air motor to drive the motor in a reverse, or counter-clockwise direction. The reversing valve 26 is selectively rotatable to fluidly connect one of the first air intake passage 90 and second air intake passage 94 with the source of compressed air for forward or reverse operation of the drill 10, respectively.

As the compressed gas enters the air motor, a pressure differential in the various fluidly-connected passages of the housing 14 drives the motor in its specified direction. The gas expands as it passes through the motor, eventually being exhausted from the motor. The expanded gas exits the motor via a primary air exhaust passage 98 through the housing 14. The reversing valve 26 includes a primary exhaust vent 102 fluidly connected with the primary air exhaust passage 98 to allow passage of the exhausted air from the air motor. The primary exhaust vent 102 is defined by a necked portion 106 of the reversing valve 26 (FIG. 1). The necked portion 106 of the reversing valve 26 allows the exhausted air to flow past the valve 26 without restriction and into an air outlet passage 110 in the handle 50. The air outlet passage 110 includes a muffler 114 positioned near the bottom of the air outlet passage 110 to help disperse and muffle the exhausted air before it exits the handle 50 through an outlet vent 118. The outlet vent 118 is positioned adjacent the coupling adapter 54 at the bottom end of the handle 50.

As shown in FIG. 3, the reversing valve 26 further includes a first secondary exhaust vent 122 and a second secondary exhaust vent 126 formed therein. The secondary exhaust vents 122, 126 fluidly connect that air intake passage (94 or 90) that is not receiving the compressed air with the primary exhaust vent 102 of the valve 26. During forward operation of the drill 10, for example, the reversing valve 26 is rotated to fluidly connect the first air intake passage 90 with the source of compressed air. Subsequently, the first secondary exhaust vent 122 fluidly connects the second air intake passage 94 with the primary exhaust vent 102 of the valve 26, thereby allowing the motor increased capacity to exhaust the expanded air from the motor. Similarly, during reverse operation of the drill 10, for example, the reversing valve 26 is rotated to fluidly connect the second air intake passage 94 with the source of compressed air. The second secondary exhaust vent 126 then fluidly connects the first air intake passage 90 with the primary exhaust vent 102 of the valve 26, thereby allowing the motor increased capacity to exhaust the expanded air from the motor.

With reference to FIG. 1, the reversing valve 26 also includes a tab 130 formed toward the end of the valve 26 which is exterior of the housing 14. The tab 130 allows a user to rotate the valve 26 to select forward or reverse operation of the drill 10. The housing 14 includes a spring detent 134 therein (FIG. 2) to engage notches 138, 142 in the valve 26 that correspond with forward and reverse operation of the drill 10, respectively. When rotated to select either forward or reverse operation of the drill 10, the spring detent 134 engages the respective notch 138, 142 to help prevent the valve 26 from accidental rotation while the user is depressing the trigger 42 or handling the drill 10.

With reference to FIG. 2, an inner o-ring 146 is situated in the housing 14 around the valve 26 to fluidly separate the air inlet passage 58 and the air outlet passage 110 at their interface with the reversing valve 26. Also, an outer o-ring 150 is situated in and around the valve 26 to fluidly separate the primary air exhaust passage 98 and the air outlet passage 110 from the exterior of the housing 14. Further, the outer o-ring 150 prevents contaminants from entering the drill housing 14.

During operation of the drill 10, the user depresses the trigger 42 to cause the flared portion 46 of the trigger shaft 34 to engage and tilt the tilt valve 62 off of the sealing surface 70. Progressive displacement of the trigger 42 further tilts the tilt valve 62 off of the sealing surface 70, thus allowing a corresponding progressive amount of compressed air past the tilt valve 62. Also, the reversing valve 26 may be rotated to a position between that defined by the notches 138, 142 to misalign the valve outlet 86 with the desired air intake passage 90, 94. This provides another way of regulating the flow of incoming compressed air through the desired air intake passage 90, 94, thus regulating the torque output of the motor and chuck 18.

Since the reversing valve 26 is part of the trigger assembly 22, only the blind bore 30 for the trigger assembly 22 is machined during manufacture of the drill 10. This is in contrast to a conventional air-operated reversible drill, which requires a separate machined bore in the drill housing to contain a conventional push-button selector valve apart from the trigger assembly, which also requires a machined area on the drill housing. Elimination of the additional machining processes results in a more cost-effective design.

Also, the tab 130 is integrally formed with the reversing valve 26, which is in contrast with the conventional push-button selector valve that typically requires additional components, such as a lever and a retaining plate, for example, to allow the user to rotate the selector valve to adjust the torque output of the motor and chuck. Elimination of these additional components results in a more simple, robust, and cost-effective design.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described herein are further intended to explain best modes known for practicing the invention and to enable others skilled in the art to utilize the invention in such, or other, embodiments and with various modifications required by the particular applications or uses of the present invention.

1. A pneumatic power tool comprising:
a housing formed to include a handle;
an air motor positioned within the housing;
an air inlet passage through the handle, the air inlet passage being connectable with a source of pressurized air;
a tilt valve positioned in the air inlet passage to control airflow through the air inlet passage;
a first air intake passage through the housing, the first air intake passage being in fluid communication with the motor;
a second air intake passage through the housing, the second air intake passage being in fluid communication with the motor;
an air exhaust passage through the housing, the air exhaust passage being in fluid communication with the motor;
an air outlet passage through the handle, the air outlet passage being in fluid communication with an exterior of the pneumatic power tool;
a rotatable reverse valve positioned within the housing, the reverse valve fluidly coupling the air exhaust passage and the air outlet passage, the reverse valve being rotatable between a first position fluidly connecting the air inlet passage to the first air intake passage to operate the motor in a first direction and a second position fluidly connecting the air inlet passage to the second air intake passage to operate the motor in a second direction, which is opposite the first direction; and
a throttle shaft having a first end and a second end, the throttle shaft extending slidably through the reverse valve, the first end of the shaft engaging the tilt valve and the second end of the shaft extending outside of the housing for engagement by a user to regulate the airflow past the tilt valve.

2. The pneumatic power tool of Claim 1, wherein the pressurized air originating from the air inlet passage flows through the reverse valve in a substantially straight path.

3. The pneumatic power tool of Claim 1, wherein the air outlet passage is substantially parallel with the air inlet passage.

4. The pneumatic power tool of Claim 1, wherein the reverse valve includes a generally cylindrical exterior surface, and wherein the reverse valve is insertable into a circular bore in the housing.

5. The pneumatic power tool of Claim 4, wherein the reverse valve includes a first portion, in which the air outlet passage is fluidly coupled with the air exhaust passage, and a second portion, in which the air inlet passage is fluidly coupled with one of the first and second air intake passages.

6. The pneumatic power tool of Claim 5, wherein a seal is positioned between the housing and the reverse valve to fluidly separate the first and second portions of the reverse valve.

7. The pneumatic power tool of Claim 5, wherein the first portion includes a cross section having a smaller diameter than that of a cross section of the second portion.

8. The pneumatic power tool of Claim 5, wherein the second portion includes an inlet opening and an outlet opening, wherein the inlet opening is adjacent the air inlet passage, wherein the outlet opening is adjacent the first and second air intake passages, and wherein the inlet opening and outlet opening are in fluid communication with each other.

9. The pneumatic power tool of Claim 8, wherein the inlet opening is larger than the outlet opening.

10. The pneumatic power tool of Claim 8, wherein in the first and second positions, the inlet opening is in fluid communication with the air inlet passage.

11. The pneumatic power tool of Claim 10, wherein in the first position, the outlet opening is in fluid communication with the first air intake passage.

12. The pneumatic power tool of Claim 10, wherein in the second position, the outlet opening is in fluid communication with the second air intake passage.

13. The pneumatic power tool of Claim 1, wherein the reverse valve defines an exhaust vent groove extending along the valve, and wherein in the first position, the exhaust vent fluidly couples the second air intake passage and the air outlet passage.

14. The pneumatic power tool of Claim 13, wherein the exhaust vent is a first exhaust vent, wherein the reverse valve defines a second exhaust vent extending along the valve and parallel to the first exhaust vent, and wherein in the second position, the second exhaust vent fluidly couples the first air intake passage and the air outlet passage.

15. The pneumatic power tool of Claim 1, wherein the reverse valve includes a tab positioned adjacent to the second end of the shaft and engageable by a user to move the reverse valve between its first and second positions.

16. A pneumatic power tool comprising:
a housing formed to include a handle;
an air motor positioned within the housing;
an air inlet passage through the handle, the air inlet passage being connectable with a source of pressurized air;
a tilt valve positioned in the air inlet passage to control airflow through the air inlet passage;
a first air intake passage through the housing, the first air intake passage being in fluid communication with the motor;
a second air intake passage through the housing, the second air intake passage being in fluid communication with the motor;
an air exhaust passage through the housing, the air exhaust passage being in fluid communication with the motor;
an air outlet passage through the handle, the air outlet passage being in fluid communication with an exterior of the pneumatic power tool;
a rotatable reverse valve positioned within the housing, the reverse valve including an exhaust portion fluidly coupling the air exhaust passage and the air outlet passage, and an intake portion adjacent the exhaust portion, the intake portion being rotatable between a first position fluidly connecting the air inlet passage to the first air intake passage to operate the motor in a first direction and a second position fluidly connecting the air inlet passage to the second air intake passage to operate the motor in a second direction, the second direction being opposite the first direction;
a throttle shaft having a first end and a second end, the throttle shaft extending slidably through the reverse valve, the first end of the shaft engaging the tilt valve and the second end of the shaft extending outside of the housing for engagement by a user to regulate the airflow past the tilt valve; and
a tab coupled to the reverse valve and positioned adjacent to the second end of the shaft, the tab engageable by a user to move the reverse valve between its first and second positions.

17. The pneumatic power tool of Claim 16, wherein the pressurized air originating from the air inlet passage flows through the reverse valve in a substantially straight path.

18. The pneumatic power tool of Claim 16, wherein a seal is positioned between the housing and the reverse valve to fluidly separate the intake and exhaust portions of the reverse valve.

19. The pneumatic power tool of Claim 16, wherein the reverse valve includes a generally cylindrical exterior surface, and wherein the reverse valve is insertable into a circular bore in the housing.

20. The pneumatic power tool of Claim 19, wherein the exhaust portion includes a cross section having a smaller diameter than that of a cross section of the intake portion.

21. The pneumatic power tool of Claim 16, wherein the intake portion includes an inlet opening and an outlet opening, wherein the inlet opening is adjacent the air inlet passage, wherein the outlet opening is adjacent the first and second air intake passages, and wherein the inlet opening and outlet opening are in fluid communication with each other.

22. The pneumatic power tool of Claim 21, wherein the inlet opening is larger than the outlet opening.

23. The pneumatic power tool of Claim 21, wherein in the first and second positions, the inlet opening is in fluid communication with the air inlet passage.

24. The pneumatic power tool of Claim 21, wherein in the first position, the outlet opening is in fluid communication with the first air intake passage.

25. The pneumatic power tool of Claim 21, wherein in the second position, the outlet opening is in fluid communication with the second air intake passage.

26. The pneumatic power tool of Claim 16, wherein the reverse valve defines an exhaust vent extending along the valve, and wherein in the first position, the exhaust vent fluidly couples the second air intake passage and the air outlet passage.

27. The pneumatic power tool of Claim 16, wherein the exhaust vent is a first exhaust vent, wherein the reverse valve defines a second exhaust vent extending along the valve and parallel to the first exhaust vent, and wherein in the second position, the second exhaust vent fluidly couples the first air intake passage and the air outlet passage.

28. The pneumatic power tool of Claim 16, wherein the tab is integrally formed with the reverse valve.

29. A pneumatic power tool comprising:
a housing formed to include a handle;
an air motor positioned within the housing;
an air inlet passage through the handle, the air inlet passage being connectable with a source of pressurized air;
a tilt valve positioned in the air inlet passage to control airflow through the tool;
a rotatable reverse valve positioned within the housing, the reverse valve being rotatable between a first position to operate the motor in a first direction and a second position to operate the motor in a second direction, which is opposite the first direction;
a slidable throttle shaft having a first end and a second end, the throttle shaft extending axially through the reverse valve, the first end of the shaft engaging the tilt valve and the second end of the shaft extending outside of the housing for engagement by a user to regulate the airflow past the tilt valve; and
a tab portion coupled to the reverse valve and positioned adjacent to the second end of the shaft, the tab portion engageable by a user to move the reverse valve between its first and second positions.

30. The pneumatic power tool of Claim 29, wherein the pressurized air originating from the air inlet passage flows through the reverse valve in a substantially straight path.

31. The pneumatic power tool of Claim 29, wherein the reverse valve includes a generally cylindrical exterior surface, and wherein the reverse valve is insertable into a circular bore in the housing.

32. The pneumatic power tool of Claim 29, further comprising a spring detent mechanism positioned in the housing and engageable with the reverse valve to maintain the valve in one of the first and second positions.

33. The pneumatic power tool of Claim 29, further comprising a pin coupled to the housing and engageable with the reverse valve to substantially prevent axial movement of the reverse valve relative to the housing.
